(19) United States
(12) Patent Application Publication
(10) Pub. No.: US 2024/0419962 A1
(43) Pub. Date: Dec. 19, 2024

(54) MACHINE LEARNING-BASED TECHNIQUES FOR OPTIMIZING CONFIGURATION PARAMETERS IN TARGET DETECTION ALGORITHMS OR OTHER ALGORITHMS

(71) Applicant: Raytheon Company, Waltham, MA (US)

(72) Inventors: Alex F. Haufler, Hermosa Beach, CA (US); Gamze Erten, Redondo Beach, CA (US); James W. Hribal, Arlington, VA (US)

(21) Appl. No.: 18/333,712

(22) Filed: Jun. 13, 2023

(51) Int. Cl. G06N 3/08

(52) U.S. Cl. CPC G06N 3/08; G06V 20/40

(57) ABSTRACT

A method includes obtaining an image of a scene and identifying one or more statistics associated with each of multiple processing regions within the image, where each processing region represents a portion of the image. The method also includes generating a probability of each of the processing regions containing at least one object of interest based on the statistics associated with the processing regions. The method further includes allocating multiple processing windows to one or more of the processing regions based on the probabilities, where the processing windows are smaller than the processing regions. In addition, the method includes performing object detection within the allocated processing windows.

### GOVERNMENT RIGHTS

This invention was made with U.S. government support under contract number FA8810-18-C-0005 awarded by the Department of Defense. The U.S. government may have certain rights in this invention.

### TECHNICAL FIELD

This disclosure is generally directed to object detection systems and other detection systems. More specifically, this disclosure is directed to machine learning-based techniques for optimizing configuration parameters in target detection algorithms or other algorithms.

### BACKGROUND

Various systems perform object detection and tracking or other target detection operations in order to support one or more additional functions. For example, in the defense space, target detection may be performed by satellites, aircraft, or other platforms in order to identify hostile aircraft, missiles, or other objects. In the commercial space, target detection may be performed by aircraft or other platforms to identify nearby objects (such as other aircraft) or to otherwise identify other objects that might pose safety concerns.

### SUMMARY

This disclosure relates to machine learning-based techniques for optimizing configuration parameters in target detection algorithms or other algorithms.

In a first embodiment, a method includes obtaining an image of a scene and identifying one or more statistics associated with each of multiple processing regions within the image, where each processing region represents a portion of the image. The method also includes generating a probability of each of the processing regions containing at least one object of interest based on the statistics associated with the processing regions. The method further includes allocating multiple processing windows to one or more of the processing regions based on the probabilities, where the processing windows are smaller than the processing regions. In addition, the method includes performing object detection within the allocated processing windows. In related embodiments, a non-transitory machine readable medium contains instructions that when executed cause at least one processor to perform the method of the first embodiment.

In a second embodiment, an apparatus includes at least one memory configured to store an image of a scene. The apparatus also includes at least one processing device configured to identify one or more statistics associated with each of multiple processing regions within the image, where each processing region represents a portion of the image. The at least one processing device is also configured to generate a probability of each of the processing regions containing at least one object of interest based on the statistics associated with the processing regions. The at least one processing device is further configured to allocate multiple processing windows to one or more of the processing regions based on the probabilities, where the processing windows are smaller than the processing regions. In addition, the at least one processing device is configured to perform object detection within the allocated processing windows.

In a third embodiment, a method includes obtaining a labeled training dataset, where the labeled training dataset includes training images that are known to contain objects, training images that are known to not contain objects, and labels indicating which of the training images contain and do not contain objects. The method also includes training a machine learning model to generate probabilities that processing regions within captured images contain at least one object, where each processing region represents a portion of the corresponding captured image. In related embodiments, an apparatus includes at least one processing device configured to perform the method of the third embodiment. In other related embodiments, a non-transitory machine readable medium contains instructions that when executed cause at least one processor to perform the method of the first embodiment.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate an example application for machine learning-based optimization of configuration parameters for a target detection algorithm or other algorithm according to this disclosure;

FIG. 3 illustrates an example device supporting machine learning-based optimization of configuration parameters for a target detection algorithm or other algorithm according to this disclosure;

FIG. 4 illustrates an example method for machine learning-based optimization of configuration parameters for a target detection algorithm or other algorithm according to this disclosure; and

FIG. 5 illustrates an example method for training one or more machine learning models for optimization of configuration parameters for a target detection algorithm or other algorithm according to this disclosure.

### DETAILED DESCRIPTION

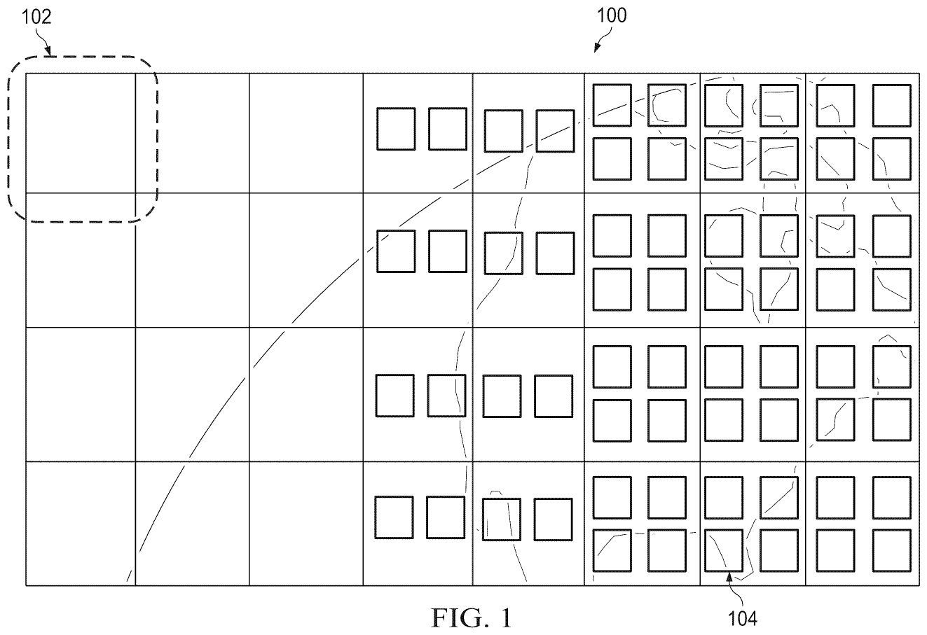

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, various systems perform object detection and tracking or other target detection operations in order to support one or more additional functions. For example, in the defense space, target detection may be performed by satellites, aircraft, or other platforms in order to identify hostile aircraft, missiles, or other objects. In the commercial space, target detection may be performed by aircraft or other platforms to identify nearby objects (such as other aircraft) or to otherwise identify other objects that might pose safety concerns.

Various algorithms have been developed that attempt to increase the probability of target detection and reduce the probability of false alarms. A false alarm refers to an instance in which a potential object of interest is identified but is eventually determined to not be an actual object of interest. In some cases, the false alarm probability needs to be reduced since identifying potential objects of interest and transmitting information about those potential objects of interest can be subject to processing or throughput constraints. In other words, there may be limited processing resources available for identifying potential objects of interest, or there may be limited communication resources available for transmitting information about those identified potential objects of interest. As a result, reducing the probability of falsely identifying potential objects of interest can help to focus usage of these resources on identifying actual objects of interest.

In some implementations, these algorithms use target-likelihood models for identifying objects of interest that have a higher likelihood of being actual targets to be identified. These target-likelihood models can be based on parametric functions of statistics related to each region of images being processed. The parameters in the target-likelihood models typically need to be optimized for a particular type of scene, background clutter, target characteristics, sensor characteristics, and imaging modality. Currently, the optimization of the parameters in the target-likelihood models is based on the expertise of subject matter experts. These manual approaches are typically iterative and involve setting the model parameters, performing lengthy simulations, and making incremental changes to the model parameters in order to learn the effects of each parameter on the model and detection performance. Unfortunately, this makes the optimization of the parameters in the target-likelihood models time-consuming, slow, and expensive, and the overall results that are obtained can still be sub- optimal even with considerable effort.

This disclosure provides various techniques for optimizing configuration parameters in target detection algorithms or other algorithms. As described in more detail below, one or more images of a scene can be obtained, where target detection is to be performed using the one or more images. The one or more images can be processed in order to generate one or more statistics for each of multiple processing regions within the image(s). Each processing region represents a portion of the image(s), and the one or more statistics relate to the likelihood of a target object of interest being present in each processing region. The one or more statistics can be used to generate a probability of a target object of interest being present in each processing region, and the probabilities for the various processing regions can be used to allocate processing windows to one or more of the processing regions. Each processing window represents a portion of at least one processing region that can be analyzed further in order to perform target detection. This helps to increase or maximize the probability of one or more target objects being detected across the processing regions. Optionally, a position of each processing window may be selected in order to increase or maximize the probability of one or more target objects being detected within the associated processing region.

In some embodiments, one or more machine learning models may generate configuration parameters that are used to allocate the processing windows to the processing regions and optionally to position the processing windows within the processing regions. For example, configuration parameters may be used when converting the statistics associated with the processing regions into probabilities of target objects being detected within those processing regions. Other configuration parameters may be used when determining positions for the processing windows within one or more of the processing regions. The one or more machine learning models can be trained using suitable training data (such as one or more labeled training datasets) in order to optimally allocate the processing windows to the processing regions and optionally to optimally position the processing windows within the processing regions.

In this way, the described techniques help to increase or maximize the probability of target objects being identified successfully, which can help to increase the effectiveness of an overall system that uses or relies upon the successful identification of the target objects. Moreover, this can occur within systems that are more resource-constrained, such as those systems that are more constrained in terms of processing or communication resources available for use (like satellites and drones). Among other reasons, this is because the described techniques can reduce or minimize false alarms, which helps to focus usage of the processing or communication resources on actual target objects of interest. Further, the described techniques allow target-likelihood models or other models to be created faster, easier, and with reduced cost compared to those approaches relying on human experts. In addition, the described techniques allow the target-likelihood models or other models to be retrained as needed, such as when additional or more accurate training data becomes available.

Note that the techniques described in this disclosure may be used in any suitable applications in which resource allocation may be needed or desired based on a number of objects identified. For example, in some cases, the described techniques may be used on satellites, drones, aircraft, or other platforms to identify and track other objects (such as for commercial or defense purposes). In other cases, the described techniques may be used in logistics applications where resource allocations are optimized based on a number of objects identified. While the following discussion often uses a satellite configured to track objects as an example use case, this disclosure is not limited to that specific use case. In general, the described techniques may be broadly applicable to a number of applications, including those involving target detection through sensor-based imaging modalities.

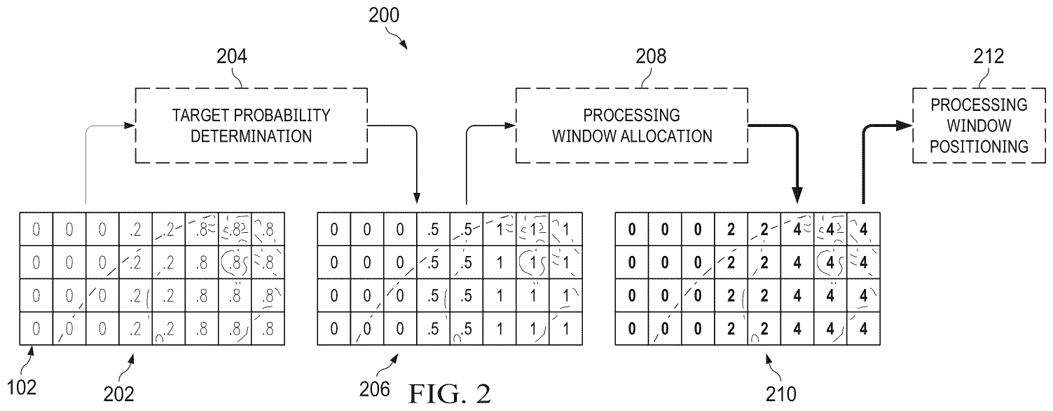

FIGS. 1 and 2 illustrate an example application for machine learning-based optimization of configuration parameters for a target detection algorithm or other algorithm according to this disclosure. As shown in FIG. 1, an image 100 of a scene has been captured and is being processed for target detection. In this particular example, the image 100 captures a portion of the Earth from space, although any other suitable images of any other suitable scenes may be captured and analyzed here. The image 100 may be obtained in any suitable manner, such as when the image 100 is captured by a camera or other imaging sensor of a satellite or other platform. The image 100 may have any suitable resolution and may include image data of any suitable form. The image 100 may represent a single image or an image forming part of a sequence of images.

The image 100 is divided into multiple processing regions 102, where each processing region 102 represents a portion of the image 100. In this example, the image 100 is divided into a 4×8 grid of processing regions 102, and the processing regions 102 have equal or substantially equal sizes. However, the specific number, arrangement, and size(s) of the processing regions 102 can vary depending on the implementation. For example, in some cases, the processing regions 102 can be generated statically, such as when each image 100 or collection of images 100 is divided into the same set of processing regions 102 (which may be predefined in some instances). In other cases, the processing regions 102 can be generated dynamically, such as when each image 100 or collection of images 100 is divided into processing regions 102 such that each processing region 102 captures a similar level or type of clutter across that processing region 102. In general, this disclosure is not limited to any specific technique for identifying the processing regions 102 within one or more images 100.

In an ideal case, all image data associated with each processing region 102 can be processed in order to perform target object detection. However, in reality, many image processing platforms may lack the processing, memory, communication, or other resources needed to perform target object detection across all processing regions 102 of all images 100 being captured and analyzed. In these or other situations, a number of processing windows 104 may be distributed across each image 100. Each processing window 104 represents a portion of at least one processing region 102 that can be analyzed further in order to perform target object detection. For example, an image processing platform may be able to analyze the image data within a specified number of processing windows 104 in order to determine whether at least one object of interest is detected within any of those processing windows 104.

Because of this, the allocation of the processing windows 104 to the processing regions 102 represents an allocation problem in which it is determined how to optimally allocate a fixed number of resources (the processing windows 104) spatially within the image 100 in order to increase or maximize the probability of success target detection while reducing or minimizing the probability of false alarms. As described below, this process can be governed by one or more spatial statistics associated with the image data within the processing regions 102. For example, assume there are fifty processing windows 104 that can be allocated to the processing regions 102. One goal here can include determining how to distribute the processing windows 104 to the processing regions 102 in order to enable target detection within the image 100 based on the statistics of the processing regions 102. The allocation of the processing windows 104 to the processing regions 102 ideally enables a maximum number of targets to be identified within the processing windows 104 across all of the processing regions 102.

As shown in FIG. 2, an example process 200 illustrates how the processing windows 104 may be allocated to the processing regions 102. In this example, various statistics 202 have been generated for the processing regions 102 associated with the image 100. Here, a single statistic 202 is shown for each processing region 102, although multiple statistics 202 may be generated for each processing region 102.

The statistics 202 identify or relate to the likelihood of a target object of interest being present in each processing region 102. The specific statistics 202 that are used and the specific calculations of those statistics 202 can vary based on the application. That is, the likelihood of a target object of interest being present in each processing region 102 can vary based on (among other things) the specific contents of the image 100 being processed and the application. For instance, in this example, the process 200 may be used in an application for identifying aircraft or other target objects that are near or over a specified geographic area (such as central North America). Based on the specific image 100 shown in FIG. 1, the statistics 202 shown in FIG. 2 may be generated. Here, the first three columns of statistics 202 may be zero since the first three columns of processing regions 102 of the image 100 do not capture the specified geographic area or areas near the specified geographic area. The next two columns of statistics 202 may be relatively low since the next two columns of processing regions 102 of the image 100 are closer to the specified geographic area. The last three columns of statistics 202 may be relatively high since the last three columns of processing regions 102 of the image 100 include the specified geographic area. If another image is captured with the specified geographic area more centered in the image, the columns of statistics 202 may include higher values in the central processing regions 102 and lower values moving left and right. Note that while this example is relatively simplistic, it is provided merely to illustrate how the statistics 202 can vary based on the specific image being processed and the intended application.

A target probability determination function 204 processes the statistics 202 associated with one or more images 100 in order to generate probabilities 206. Each of the probabilities 206 represents a probability of at least one target object of interest being present in the corresponding processing region 102 given the contents of the image(s) 100. In other words, the target probability determination function 204 converts the statistics 202 associated with the processing regions 102 of the image(s) 100 into corresponding normalized probabilities 206 that target objects may be present within those processing regions 102. The target probability determination function 204 may be said to implement a probability function Pr(qₖ|γₖ), where qₖ represents a specific processing region 102 and γₖ represents the statistic(s) 202 associated with that specific processing region 102.

In some embodiments, the target probability determination function 204 may be implemented using a trained machine learning model. For example, the machine learning model may be trained to process statistics 202 for the processing regions 102 in order to generate the probabilities 206 of target objects being present in the processing regions 102. As a particular example, a linear support vector machine (SVM) or other machine learning model may be used, where the linear SVM or other machine learning model generates a weighted sum of multiple statistics 202 for each processing region 102. The weights used to produce the weighted sum for each processing region 102 may represent configuration parameters of the machine learning model and can be denoted as (α₁, . . . , α_{N}). Note, however, that the machine learning model used to implement the target probability determination function 204 may support any other suitable function for determining the probabilities 206.

A processing window allocation function 208 processes the probabilities 206 in order to generate allocations 210 of processing windows 104 to the processing regions 102. Each allocation 210 here represents a number of processing windows 104 allocated to the corresponding processing region 102. For example, the processing window allocation function 208 can assign fewer or no processing windows 104 to those processing regions 102 having zero or lower probabilities 206 of being associated with target objects. The processing window allocation function 208 can assign more processing windows 104 to those processing regions 102 having higher probabilities 206 of being associated with target objects. In some cases, the number of processing windows 104 assigned to each specific processing region 102 can be based on a ratio involving the probability 206 for that specific processing region 102 and the sum of all probabilities 206 across all processing regions 102. As a particular example, the number of processing windows 104 assigned to each specific processing region 102 may be determined as follows.

$${x}_{k} = \frac{T}{\frac{1}{Pr ( {q}_{k} \vert {γ}_{k} )} {\sum }_{j = 1}^{R} Pr ( {q}_{j} \vert {γ}_{j} )} \qquad ( 1 )$$

Here, T represents the total resource budget (such as the total number of processing windows 104 available for allocation), and R represents the total number of processing regions 102. Also, xₖ represents the number of processing windows 104 allocated to the k^{th} processing region 102.

A processing window positioning function 212 processes the allocations 210 in order to determine how to position the processing windows 104 within the processing regions 102 to which those processing windows 104 have been allocated. Depending on the implementation, a processing window 104 may be positioned completely within the associated processing region 102, or a processing window 104 may be positioned partially within the associated processing region 102 and partially within one or more neighboring processing regions 102. In some embodiments, the processing window positioning function 212 may be implemented using a trained machine learning model. For example, the machine learning model may be trained to process image data and allocations 210 in order to determine optimal positions for the processing windows 104 within images 100. As a particular example, the machine learning model may be trained to perform thresholding after applying a set of spatial filters to the image data contained in each processing region 102 that has been allocated one or more processing windows 104. The weights used to produce the weighted sum for the spatial filters for each processing window candidate can be denoted as (β₁, . . . , β_{M}). These parameters can be tuned to specify the processing window positioning function 212 towards determining the position(s) of the processing window(s) 104 that increase or maximize the probability of target object detection. Note that the machine learning model used to implement the processing window positioning function 212 may support any suitable function for determining positions of the processing windows 104.

Additional details regarding the functions of the process 200 are provided below. It should be noted that the functions shown in or described with respect to FIGS. 1 and 2 can be implemented in any suitable device(s) and in any suitable manner. For example, in some embodiments, at least some of the functions shown in or described with respect to FIGS. 1 and 2 can be implemented or supported using one or more software applications or other software instructions that are executed by one or more processors of an electronic device, such as one or more processors in a satellite, drone, or other platform. In other embodiments, at least some of the functions shown in or described with respect to FIGS. 1 and 2 can be implemented or supported using dedicated hardware components. In general, the functions shown in or described with respect to FIGS. 1 and 2 can be performed using any suitable hardware or any suitable combination of hardware and software/firmware instructions. Also, the functions shown in or described with respect to FIGS. 1 and 2 can be performed by a single device or by multiple devices, such as when one device captures images 100 and another device processes the images 100.

Although FIGS. 1 and 2 illustrate one example of an application for machine learning-based optimization of configuration parameters for a target detection algorithm or other algorithm, various changes may be made to FIGS. 1 and 2. For example, the image 100 and its related processing regions 102 and processing windows 104 shown in FIG. 1 are for illustration only. The contents of images 100, the definitions of processing regions 102, and the allocations of processing windows 104 can vary widely depending on the circumstances. Also, the specific statistics 202, probabilities 206, and allocations 210 that are generated can vary widely depending on the circumstances.

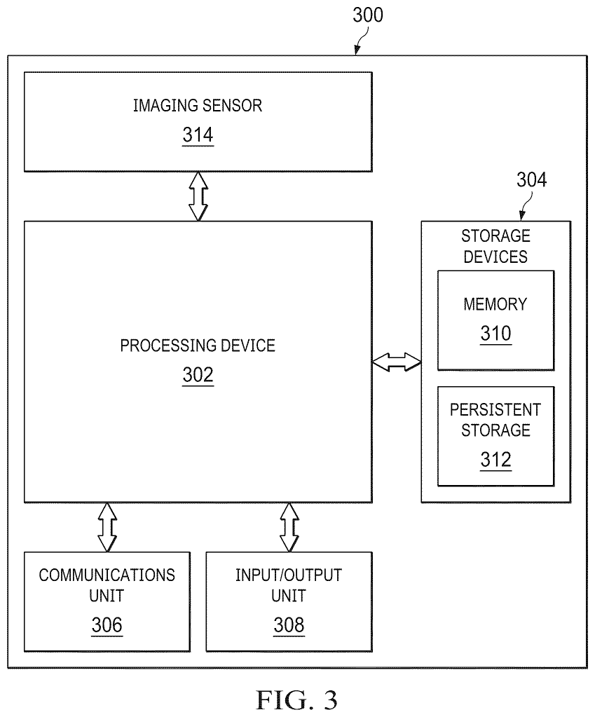

FIG. 3 illustrates an example device 300 supporting machine learning-based optimization of configuration parameters for a target detection algorithm or other algorithm according to this disclosure. For example, the device 300 may represent at least part of a platform that analyzes images 100 using the process 200 in order to perform target object detection. Note, however, that the same type of device 300 as shown in FIG. 3 may be used for other or additional purposes. For instance, the device 300 may represent a server or other computing device that is used to train one or more machine learning models for use by a separate platform that performs the process 200.

As shown in FIG. 3, the device 300 denotes a computing device or system that includes at least one processing device 302, at least one storage device 304, at least one communications unit 306, and at least one input/output (I/O) unit 308. The processing device 302 may execute instructions that can be loaded into a memory 310. The processing device 302 includes any suitable number(s) and type(s) of processors or other processing devices in any suitable arrangement. Example types of processing devices 302 include one or more microprocessors, microcontrollers, digital signal processors (DSPs), application specific integrated circuits (ASICs), field programmable gate arrays (FPGAs), or discrete circuitry.

The memory 310 and a persistent storage 312 are examples of storage devices 304, which represent any structure(s) capable of storing and facilitating retrieval of information (such as data, program code, and/or other suitable information on a temporary or permanent basis). The memory 310 may represent a random access memory or any other suitable volatile or non-volatile storage device(s). The persistent storage 312 may contain one or more components or devices supporting longer-term storage of data, such as a read only memory, hard drive, Flash memory, or optical disc.

The communications unit 306 supports communications with other systems or devices. For example, the communications unit 306 can include a network interface card or a wireless transceiver facilitating communications over a wired or wireless network. The communications unit 306 may support communications through any suitable physical or wireless communication link(s).

The I/O unit 308 allows for input and output of data. For example, the I/O unit 308 may provide a connection for user input through a keyboard, mouse, keypad, touchscreen, or other suitable input device. The I/O unit 308 may also send output to a display or other suitable output device. Note, however, that the I/O unit 308 may be omitted if the device 300 does not require local I/O, such as when the device 300 represents a satellite, drone, or other platform that can be accessed remotely.

In some cases, the device 300 includes or is coupled to one or more imaging sensors 314. Each imaging sensor 314 may be used to capture one or more images of one or more scenes. Depending on the implementation, the device 300 may include a single imaging sensor 314 or multiple imaging sensors 314. Each imaging sensor 314 represents any suitable device configured to capture images. Each imaging sensor 314 may capture images having any suitable resolution and any suitable form. As particular examples, each imaging sensor 314 may represent a camera or other imaging sensor configured to capture illumination in the visible spectrum of light, infrared spectrum of light, ultraviolet spectrum of light, or any combination thereof.

In some embodiments, instructions executed by the processing device 302 include instructions that implement the functionality related to the process 200. Thus, for example, the instructions when executed may cause the processing device 302 to obtain one or more images 100, divide the images 100 into processing regions 102, allocate processing windows 104 to the processing regions 102, position the processing windows 104 within the processing regions 102, and process image data within the processing windows 104. The instructions when executed may also cause the processing device 302 to store, output, or use the results of the image data processing, such as by using or transmitting information about one or more detected target objects. In other embodiments, instructions executed by the processing device 302 include instructions that cause the processing device 302 to train one or more machine learning models for use during the process 200.

Although FIG. 3 illustrates one example of a device 300 supporting machine learning-based optimization of configuration parameters for a target detection algorithm or other algorithm, various changes may be made to FIG. 3. For example, computing and communication devices and systems come in a wide variety of configurations, and FIG. 3 does not limit this disclosure to any particular computing or communication device or system.

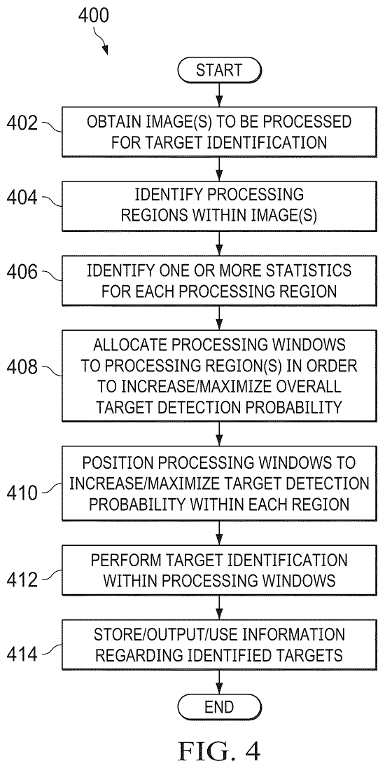

FIG. 4 illustrates an example method 400 for machine learning-based optimization of configuration parameters for a target detection algorithm or other algorithm according to this disclosure. For ease of explanation, the method 400 is described as being performed using the device 300 of FIG. 3, which may be used to perform the process 200 of FIG. 2 using one or more images 100 of FIG. 1. However, the method 400 may be performed using any other suitable device(s) and with any other suitable image(s) and process(es).

As shown in FIG. 4, one or more images to be processed for target identification are obtained at step 402. This may include, for example, the processing device 302 receiving one or more images 100 captured using one or more imaging sensors 314. If necessary or desirable, any suitable pre-processing of the one or more images 100 may occur here, such as filtering to remove noise. Processing regions within the image(s) are identified at step 404. This may include, for example, the processing device 302 dividing each image 100 into multiple processing regions 102. As noted above, the processing regions 102 may be generated statically or dynamically, such as when each image 100 or collection of images 100 is divided into the same set of processing regions 102 or is divided into processing regions 102 that capture a similar level or type of clutter across each processing region 102. One or more statistics are identified for each processing region at step 406. This may include, for example, the processing device 302 calculating one or more statistics 202 for each processing region 102 based on the image data contained in that processing region 102.

Processing windows are allocated to the processing regions in order to increase or maximize an overall target detection probability across the processing regions at step 408. This may include, for example, the processing device 302 performing the target probability determination function 204 in order to process the statistics 202 and generate probabilities 206 for the processing regions 102 of the image(s) 100. Each probability 206 can represent the probability of the associated processing region 102 containing one or more target objects of interest. In some cases, this may include the processing device 302 using a trained machine learning model to perform the target probability determination function 204 and generate the probabilities 206. This may also include the processing device 302 performing the processing window allocation function 208 in order to allocate processing windows 104 to one or more of the processing regions 102 based on the probabilities 206 determined for the processing regions 102. In some cases, this may include the processing device 302 using Equation (1) above to allocate the processing windows 104 to one or more of the processing regions 102. In general, the processing device 302 may typically allocate more processing windows 104 to processing regions 102 having higher probabilities 206 and fewer/no processing windows 104 to processing regions 102 having lower probabilities 206.

The processing windows are positioned in order to increase or maximize an overall target detection probability within individual processing regions at step 410. This may include, for example, the processing device 302 performing the processing window positioning function 212 in order to process the allocations 210 of the processing windows 104 to the processing regions 102 and identify positions for those processing windows 104 within the image(s) 100. In some cases, this may include the processing device 302 using a trained machine learning model to perform the processing window positioning function 212 and identify positions of the processing windows 104 within the image(s) 100. Note that each processing window 104 may be positioned at any suitable location within the associated processing region 102 or across two or more neighboring processing regions 102.

Target identification is performed within each processing window at step 412. This may include, for example, the processing device 302 analyzing the image data from the image(s) 100 within each processing window 104 in order to determine whether one or more target objects of interest are present within each processing window 104. Information regarding any identified target objects of interest can be stored, output, or used in some manner at step 414. This may include, for example, the processing device 302 initiating transmission of information regarding any identified target objects of interest to an external destination, such as when a satellite transmits information regarding any identified target objects of interest to a ground station, airborne platform, naval platform, or other space-based platform. This may also or alternatively include the processing device 302 tracking any identified target objects of interest over time or performing other functions related to the identified target objects of interest. In general, information associated with each identified target object of interest may be used for any suitable purpose(s) and in any suitable manner.

Although FIG. 4 illustrates one example of a method 400 for machine learning-based optimization of configuration parameters for a target detection algorithm or other algorithm, various changes may be made to FIG. 4. For example, while shown as a series of steps, various steps in FIG. 4 may overlap, occur in parallel, occur in a different order, or occur any number of times (including zero times).

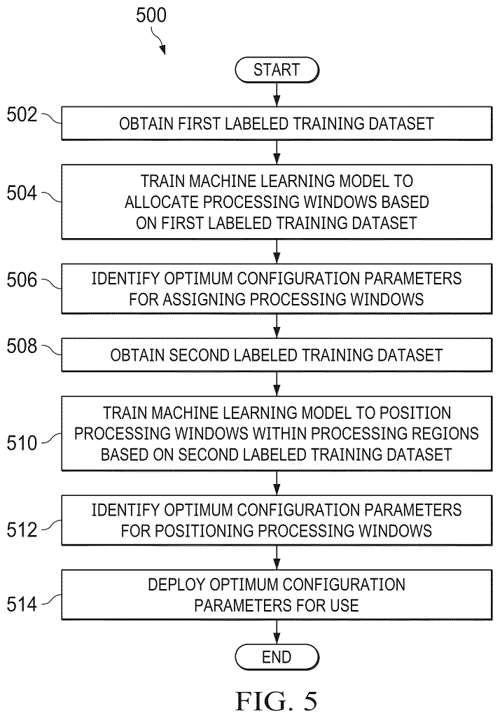

FIG. 5 illustrates an example method 500 for training one or more machine learning models for optimization of configuration parameters for a target detection algorithm or other algorithm according to this disclosure. For ease of explanation, the method 500 is described as being performed using the device 300 of FIG. 3, which may be used to train one or more machine learning models for use during the process 200 of FIG. 2. However, the method 500 may be performed using any other suitable device(s) and for any other suitable process(es).

As shown in FIG. 5, a first labeled training dataset is obtained at step 502. This may include, for example, the processing device 302 obtaining a training dataset containing training data with labels or annotations. The training data represents data that is provided to a machine learning model being trained, such as images containing known targets to be identified. The labels or annotations represent correct predictions to be generated by the machine learning model being trained based on the training data, such as correct allocations of processing windows 104 to processing regions 102 in order to detect the known targets in the images.

A machine learning model is trained to allocate processing windows to processing regions based on the first labeled training dataset at step 504. This may include, for example, the processing device 302 providing at least some of the training data of the first labeled training dataset to the machine learning model being trained and generating allocations 210 of processing windows 104 to processing regions 102 based on the training data. This may also include the processing device 302 comparing the allocations 210 to the labels or annotations of the first labeled training dataset in order to verify if the allocations 210 would be adequate to detect the known objects in the training data. In some cases, a loss value can be calculated using a loss function, where the loss value identifies the extent of the differences or errors between the actual results generated by the machine learning model and the desired results as defined by the labels or annotations. If the loss value exceeds a threshold, weights or other parameters of the machine learning model can be adjusted, and the same training data or additional training data can be provided to the machine learning model for use in generating additional results. The additional results can be compared to the corresponding labels or annotations, and an updated loss value can be determined. This process can be repeated any number of times, and ideally the loss value decreases over time and eventually falls below the threshold, which can be indicative of the machine learning model being adequately trained. Eventually, an optimum set of configuration parameters for the machine learning model is obtained at step 506. This may include, for example, the processing device 302 identifying a set of configuration parameters (α₁, . . . , α_{N}) for use by the target probability determination function 204.

Similarly, a second labeled training dataset is obtained at step 508. This may include, for example, the processing device 302 obtaining a training dataset containing training data with labels or annotations. The training data represents data that is provided to another machine learning model being trained, such as images containing known targets to be identified at known positions. The labels or annotations represent correct positions of processing windows 104 in order to detect the known targets in the images at the known positions.

Another machine learning model is trained to position processing windows based on the second labeled training dataset at step 510. This may include, for example, the processing device 302 providing at least some of the training data of the second labeled training dataset to the other machine learning model being trained and generating positions of processing windows 104 based on the training data. This may also include the processing device 302 comparing the positions of the processing windows 104 to the labels or annotations of the second labeled training dataset in order to verify if the positions of the processing windows 104 would be adequate to detect the known objects in the training data at the known positions. Again, in some cases, a loss value can be calculated using a loss function, where the loss value identifies the extent of the differences or errors between the actual results generated by the other machine learning model and the desired results as defined by the labels or annotations. If the loss value exceeds a threshold, weights or other parameters of the other machine learning model can be adjusted, and the same training data or additional training data can be provided to the other machine learning model for use in generating additional results. The additional results can be compared to the corresponding labels or annotations, and an updated loss value can be determined. This process can be repeated any number of times, and ideally the loss value decreases over time and eventually falls below the threshold, which can be indicative of the other machine learning model being adequately trained. Eventually, an optimum set of configuration parameters for the other machine learning model is obtained at step 512. This may include, for example, the processing device 302 identifying a set of configuration parameters (β₁, . . . , β_{M}) for use by the processing window positioning function 212.

The optimum configuration parameters are deployed for use at step 514. This may include, for example, the processing device 302 providing the set of configuration parameters (α₁, . . . , α_{N}) and the set of configuration parameters (β₁, . . . , β_{M}) to one or more other devices for use or placing the sets of configuration parameters into use by the device performing the training. As a particular example, this may include the processing device 302 of a server or other computing device initiating transmission of the configuration parameters to one or more satellites, drones, or other platforms for use. These platforms may use the configuration parameters to perform target identification, such as while performing the method 400 of FIG. 4.

With respect to the machine learning model used to implement the target probability determination function 204, this machine learning model may be implemented using a linear support vector machine in some embodiments as noted above. In these embodiments, this machine learning model may be trained as follows. The linear support vector machine can be used to perform classification, where each processing region 102 is classified as likely or not likely to contain at least one target object. These embodiments therefore support a classification-based approach for optimizing machine learning model parameters and rapidly producing an optimal parameter set for increased or maximum probability of detection while reducing or minimizing false alarms. The labeled training dataset used to train this machine learning model in these embodiments can include aggregations of statistics 202 for processing regions 102 with and without targets present. In some cases, the labeled training dataset can contain observations of targets across a representative set of background clutter and noise realizations.

Using this type of labeled training dataset, an SVM-based classifier can be trained on a subset of data from the labeled training dataset using a given set of statistical features (such as raw statistics or transformations of raw statistics). The parameter set for the SVM-based classifier can be determined during training, such as by using stochastic gradient descent (SGD) to minimize hinge loss across the training data with a ridge regularization of the parameters. This produces an optimal parameter set for a linear classifier based on these statistical features. The probability of false alarms and false detections for the linear classifier can be estimated, such as by using the same training dataset, using a separate testing dataset, via cross-validation, or in any other suitable manner. The estimated probability of detection can be easily controlled by varying a scalar misclassification cost hyperparameter.

At this point, the resulting machine learning model can be considered complete, where the feature space that has been learned by the machine learning model is partitioned into two regions with a binary likelihood of either one (at least one target object is likely present) or zero (at least one target object is likely not present). However, the resulting machine learning model can be extended into a continuous probability mapping, such as via the application of an activation function to calculated distances from a hyperplane classification boundary. In other words, distances between the hyperplane separating the binary classes can be converted into continuous values between zero and one (or some other suitable range) using the activation function. There are various activation functions that may be used here, such as a Heaviside, sigmoid, hyperbolic tangent, or rectified linear unit (ReLU) activation function. The activation function that is selected for use here allows for nonlinearity in the probabilities 206 determined using the resulting machine learning model, which can improve the match between the resulting machine learning model and reality (empirical data).

Note that once a database of suitable training data has been generated or otherwise obtained, training and testing of various machine learning models used to implement the target probability determination function 204 or other functions may require very little expert knowledge and can be executed very quickly. After training, an optimal parameter set can be produced and can represent the relevant statistics from the training data contained in the database. The generalizability of the machine learning models trained here may only be limited by the fidelity of the database and the statistical features available/used in the machine learning models themselves. Also note that the use of SVM classification allows for a solution that is robust against outliers in data and that optimization through SGD allows for continuous updates to a parameter set given new data to be incorporated into the database. However, the use of SVM classification and SGD optimization is for illustration and explanation only, and other approaches may use other machine learning model architectures and/or other machine learning model optimization techniques. In addition, note that the database used here may include data from any suitable source(s), such as data from high-fidelity simulations and actual operational data.

In some embodiments, the training of an SVM-based classifier may occur as follows. The training of the SVM-based classifier here may be performed in order to numerically arrive at optimum values for a set of configurable parameters (α₁, . . . , α_{N}) for regional allocation of processing windows 104 to processing regions 102 in order to increase or maximize the probability of target detection. The configurable (hyperplane) parameters here define the SVM classification-based approach, and the configurable parameters can be determined from labeled examples within a database of region statistics. During the training, the following objective function may be used.

$${max}_{{x}_{1} , {x}_{2} , … , {x}_{R}} {\sum }_{j = 1}^{R} Pr ( Target detection in {region}_{j} \vert \{ {x}_{j} , {γ}_{j} \} ) s . t . {\sum }_{j = 1}^{R} {x}_{j} = T \qquad ( 2 )$$

This can be rewritten as follows.

$${max}_{{x}_{1} , {x}_{2} , … , {x}_{R}} {\sum }_{j = 1}^{R} Pr ( Target detected \vert {x}_{j} ) \times Pr ( Target ∈ {region}_{j} \vert {γ}_{j} ) s . t . {\sum }_{j = 1}^{R} {x}_{j} = T \qquad ( 3 )$$

$${max}_{{x}_{1} , {x}_{2} , … , {x}_{R}} {\sum }_{j = 1}^{R} log {x}_{j} \times {\underbrace{Pr ( Target ∈ {region}_{j} \vert {γ}_{j} )}}_{Pr ( {q}_{j} \vert {γ}_{j} )} s . t . {\sum }_{j = 1}^{R} {x}_{j} = T \qquad ( 4 )$$

From Equation (4), the expression Pr(Target∈regionⱼ|γⱼ) represents the results from the SVM-based classifier. In some cases, the results from the SVM-based classifier may be binary and indicate either that a processing region 102 is likely or is not likely to contain one or more target objects based on its statistic(s) 202. Thus, the training dataset used with the SVM-based classifier may include image data for processing regions 102 labeled with “target” and “no target” labels, which can be used to train the SVM-based classifier to set probabilities 206 to zero for processing regions 102 that are unlikely to contain targets. An optional probability density estimation may be performed using the training data within the database to train the SVM-based classifier to estimate target probabilities for processing regions 102 that are likely to contain targets.

Although FIG. 5 illustrates one example of a method 500 for training one or more machine learning models for optimization of configuration parameters for a target detection algorithm or other algorithm, various changes may be made to FIG. 5. For example, while shown as a series of steps, various steps in FIG. 5 may overlap, occur in parallel, occur in a different order, or occur any number of times (including zero times). As a particular example, it is possible to train one of the machine learning models described with respect to FIG. 5 without training another of the machine learning models described with respect to FIG. 5.

The following describes example embodiments of this disclosure that implement or relate to machine learning-based techniques for optimizing configuration parameters in target detection algorithms or other algorithms. However, other embodiments may be used in accordance with the teachings of this disclosure.

In a first embodiment, a method includes obtaining an image of a scene and identifying one or more statistics associated with each of multiple processing regions within the image, where each processing region represents a portion of the image. The method also includes generating a probability of each of the processing regions containing at least one object of interest based on the statistics associated with the processing regions. The method further includes allocating multiple processing windows to one or more of the processing regions based on the probabilities, where the processing windows are smaller than the processing regions. In addition, the method includes performing object detection within the allocated processing windows. In related embodiments, a non-transitory machine readable medium contains instructions that when executed cause at least one processor to perform the method of the first embodiment.

In a second embodiment, an apparatus includes at least one memory configured to store an image of a scene. The apparatus also includes at least one processing device configured to identify one or more statistics associated with each of multiple processing regions within the image, where each processing region represents a portion of the image. The at least one processing device is also configured to generate a probability of each of the processing regions containing at least one object of interest based on the statistics associated with the processing regions. The at least one processing device is further configured to allocate multiple processing windows to one or more of the processing regions based on the probabilities, where the processing windows are smaller than the processing regions. In addition, the at least one processing device is configured to perform object detection within the allocated processing windows.

Any single one or any suitable combination of the following features may be used with the first or second embodiment or any related embodiment. The probabilities may be generated by processing the statistics associated with the processing regions using a machine learning model, and the machine learning model may be trained to convert the statistics associated with the processing regions into the probabilities. The machine learning model may include a support vector machine (SVM) classifier. The machine learning model may also include comprises an activation function configured to convert distances from a hyperplane classification boundary associated with the SVM classifier into probabilities along a continuous scale. The machine learning model may be trained to convert the statistics associated with the processing regions into the probabilities using a labeled training dataset. The labeled training dataset may include training images that are known to contain objects, training images that are known to not contain objects, and labels indicating which of the training images contain and do not contain objects. The machine learning model may be trained using stochastic gradient descent to minimize hinge loss across the labeled training dataset while using a ridge regularization of parameters of the machine learning model. The processing windows may be allocated to the one or more processing regions by determining a number of processing windows to allocate to each of the processing regions based on a ratio involving (i) a specified statistic associated with the processing region and (ii) a sum of the specified statistic across all of the processing regions.

In a third embodiment, a method includes obtaining a labeled training dataset, where the labeled training dataset includes training images that are known to contain objects, training images that are known to not contain objects, and labels indicating which of the training images contain and do not contain objects. The method also includes training a machine learning model to generate probabilities that processing regions within captured images contain at least one object, where each processing region represents a portion of the corresponding captured image. In related embodiments, an apparatus includes at least one processing device configured to perform the method of the third embodiment. In other related embodiments, a non-transitory machine readable medium contains instructions that when executed cause at least one processor to perform the method of the first embodiment.

Any single one or any suitable combination of the following features may be used with the third embodiment or any related embodiment. The machine learning model may be trained to convert statistics associated with the processing regions into the probabilities. The machine learning model may be trained using stochastic gradient descent to minimize hinge loss across the labeled training dataset and using a ridge regularization of parameters of the machine learning model. The machine learning model may include a support vector machine (SVM) classifier. The machine learning model may also include an activation function configured to convert distances from a hyperplane classification boundary associated with the SVM classifier into probabilities along a continuous scale. The trained machine learning model may be deployed to a platform for use in performing object detection.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining an image of a scene;
identifying one or more statistics associated with each of multiple processing regions within the image, each processing region representing a portion of the image;
generating a probability of each of the processing regions containing at least one object of interest based on the statistics associated with the processing regions;
allocating multiple processing windows to one or more of the processing regions based on the probabilities, the processing windows smaller than the processing regions; and
performing object detection within the allocated processing windows.

2. The method of claim 1, wherein generating the probabilities comprises:
processing the statistics associated with the processing regions using a machine learning model, the machine learning model trained to convert the statistics associated with the processing regions into the probabilities.

3. The method of claim 2, wherein the machine learning model comprises a support vector machine (SVM) classifier.

4. The method of claim 3, wherein the machine learning model further comprises an activation function configured to convert distances from a hyperplane classification boundary associated with the SVM classifier into probabilities along a continuous scale.

5. The method of claim 2, further comprising:
training the machine learning model to convert the statistics associated with the processing regions into the probabilities using a labeled training dataset, the labeled training dataset comprising training images that are known to contain objects, training images that are known to not contain objects, and labels indicating which of the training images contain and do not contain objects.

6. The method of claim 5, wherein training the machine learning model comprises using stochastic gradient descent to minimize hinge loss across the labeled training dataset while using a ridge regularization of parameters of the machine learning model.

7. The method of claim 1, wherein allocating the processing windows to the one or more processing regions comprises:
determining a number of processing windows to allocate to each of the processing regions based on a ratio involving (i) a specified statistic associated with the processing region and (ii) a sum of the specified statistic across all of the processing regions.

8. An apparatus comprising:
at least one memory configured to store an image of a scene; and
at least one processing device configured to:
identify one or more statistics associated with each of multiple processing regions within the image, each processing region representing a portion of the image;
generate a probability of each of the processing regions containing at least one object of interest based on the statistics associated with the processing regions;
allocate multiple processing windows to one or more of the processing regions based on the probabilities, the processing windows smaller than the processing regions; and
perform object detection within the allocated processing windows.

9. The apparatus of claim 8, wherein, to generate the probabilities, the at least one processing device is configured to process the statistics associated with the processing regions using a machine learning model, the machine learning model trained to convert the statistics associated with the processing regions into the probabilities.

10. The apparatus of claim 9, wherein the machine learning model comprises a support vector machine (SVM) classifier.

11. The apparatus of claim 10, wherein the machine learning model further comprises an activation function configured to convert distances from a hyperplane classification boundary associated with the SVM classifier into probabilities along a continuous scale.

12. The apparatus of claim 9, wherein the at least one processing device is further configured to train the machine learning model to convert the statistics associated with the processing regions into the probabilities using a labeled training dataset, the labeled training dataset comprising training images that are known to contain objects, training images that are known to not contain objects, and labels indicating which of the training images contain and do not contain objects.

13. The apparatus of claim 12, wherein, to train the machine learning model, the at least one processing device is configured to use stochastic gradient descent to minimize hinge loss across the labeled training dataset and use a ridge regularization of parameters of the machine learning model.

14. The apparatus of claim 8, wherein, to allocate the processing windows to the one or more processing regions, the at least one processing device is configured to determine a number of processing windows to allocate to each of the processing regions based on a ratio involving (i) a specified statistic associated with the processing region and (ii) a sum of the specified statistic across all of the processing regions.

15. A method comprising:
obtaining a labeled training dataset, the labeled training dataset comprising training images that are known to contain objects, training images that are known to not contain objects, and labels indicating which of the training images contain and do not contain objects; and
training a machine learning model to generate probabilities that processing regions within captured images contain at least one object, each processing region representing a portion of the corresponding captured image.

16. The method of claim 15, wherein the machine learning model is trained to convert statistics associated with the processing regions into the probabilities.

17. The method of claim 15, wherein training the machine learning model comprises using stochastic gradient descent to minimize hinge loss across the labeled training dataset and using a ridge regularization of parameters of the machine learning model.

18. The method of claim 15, wherein the machine learning model comprises a support vector machine (SVM) classifier.

19. The method of claim 18, wherein the machine learning model further comprises an activation function configured to convert distances from a hyperplane classification boundary associated with the SVM classifier into probabilities along a continuous scale.

20. The method of claim 15, further comprising:
deploying the trained machine learning model to a platform for use in performing object detection.
